(19) United States
(12) Patent Application Publication
(10) Pub. No.: US 2003/0081511 A1
(43) Pub. Date: May 1, 2003

(54) CONTROLLING CD CHANGERS TO ADVANCE TO AND PLAY TRACKS OF CD'S FOR RECORDING OF AUDIO INFORMATION OF SAME ONTO BLANK CD

(76) Inventor: Sherry R. Dryja, Sammamish, WA (US)

Correspondence Address: LAW OFFICES OF MICHAEL DRYJA, 704 228TH AVENUE NE, PMB 694, SAMMAMISH, WA, 98074, US

(21) Appl. No.: 09/682,884

(22) Filed: Oct. 30, 2001

(51) Int. Cl. G11B 7/085

(52) U.S. Cl. 369/30.06; 369/30.09

(57) ABSTRACT

Controlling compact disc (CD) changers for recording tracks from CD's stored in the CD changers onto blank CD's in a CD recording mechanism is disclosed. A CD recorder of the invention includes one or more inputs, one or more control mechanisms, a user interface mechanism, and a CD recording mechanism. The inputs are for receiving audio information from the one or more corresponding CD changers. The control mechanisms are for controlling the CD changers. The user interface mechanism allows a user to select a desired ordered list of tracks from CD's stored in the CD changers for recording onto a blank CD. The CD recording mechanism is receptive to the blank CD, and capable of recording the desired ordered list of tracks selected by the user from the CD's stored in the CD changers onto the blank CD.

### BACKGROUND OF INVENTION

This invention relates generally to audio compact discs (CD's), and more particularly to CD changers and recorders.

The compact disc (CD) has become very popular as a medium for recorded music. Most consumers, and especially audio enthusiasts, choose to buy music recorded on CD's, instead of on tapes or records. Early CD players only had the capability to load one CD at a time. Therefore, when a user wanted to listen to a different CD, he or she had to unload one CD, and load another CD in its place. More recently, CD changers have become popular. CD changers allow for a number of CD's to be loaded at a single time, so that users can switch among different CD's without having to continually load and unload them.

There are a number of different types of CD changers. Carousel-type CD changers allow a number of CD's, usually four to six, to be placed in a concentric fashion face-up, and some even allow one or more CD's to be changed when a different CD is playing. Magazine-type CD changers allow a number of CD's, usually six to eight, to be inserted into a magazine cartridge, which is then inserted into the changer. So-called jukebox-type CD changers allow 50, 100, 200, or more CD's to be inserted vertically, giving their users the ability to store almost their entire CD collection. Newer changers that accept four to eight CD's have users feed CD's individually into the changers, without the need for a magazine. Some CD changers can even be daisy-chained together, where one of the changers is the master changer that controls the other changers, giving users an even greater CD storage capacity.

CD recorders have also become popular, both as stand-alone audio components, and as drives connected to or inserted into computers. CD recorders allow users to copy CD's, and to record mix CD's containing songs from other CD's the users own. Recording a CD is generally referred to as burning a CD, because a laser beam is used to record the audio information on the CD. Extracting a song or a track from an existing CD, so that it can be recorded on a blank CD, is sometimes referred to as a ripping a CD, as the track is ripped from the CD for recording on a blank CD. Mix CD's are especially popular, because they enable users to select their favorite songs from their CD collections to place on single discs. For example, a user may create a dance music CD, a romantic music CD, seasonally themed CD's, and so on.

Unfortunately, extracting tracks from existing CD's, arranging them in a desired order, and burning them on a new mix CD can be an inconvenient process, especially if the user already owns a CD changer in which he or she has placed a large number of CD's. With computer CD recorders, the user has to individually place a CD from which one or more songs are to be ripped into a CD drive, extract the songs, and repeat this process for each CD on which desired songs are stored. The extracted songs are then burned onto a blank CD. The process is similar for stand-alone CD recorders. The difficulty primarily lies in the fact that if the user has a large number of CD's already stored in a CD changer, especially a jukebox-type CD changer, he or she first has to remove the CD's from the changer to record a mix CD. Once the desired songs have been extracted from these CD's, the user then has to reinsert them into the CD changer.

Overall, this process is time-consuming and inconvenient. Furthermore, in the case of stand-alone CD recorders, there is usually little visual information provided to the user to indicate the status of what is going on, in terms of capacity left on the blank CD being recorded, the names of the songs being ripped from existing CD's, and so on. Many users find themselves not recording as many mix CD's as they thought they would when having purchased a CD recorder. For these and other reasons, therefore, there is a need for the present invention.

### SUMMARY OF INVENTION

The invention relates to controlling compact disc (CD) changers for recording tracks from CD's stored in the CD changers onto blank CD's in a CD recording mechanism. A CD recorder of the invention includes one or more inputs, one or more control mechanisms, a user interface mechanism, and a CD recording mechanism. The inputs are for receiving audio information from the one or more corresponding CD changers. The control mechanisms are for controlling the CD changers. The user interface mechanism allows a user to select a desired ordered list of tracks from CD's stored in the CD changers for recording onto a blank CD. The CD recording mechanism is receptive to the blank CD, and capable of recording the desired ordered list of tracks selected by the user from the CD's stored in the CD changers onto the blank CD.

Embodiments of the invention provide for advantages over the prior art. The user significantly does not have to remove the CD's he or she has previously stored in a CD changer in order to record mix CD's of tracks from these CD's. The CD recorder of the invention controls the CD changer, allowing the user to select tracks from the CD's stored in the changer in an ordered list for recording onto a blank CD. Preferably the CD recorder presents the user with names of the tracks of the CD's stored in the changer, as may have been looked up in a database after initially scanning the CD's stored in the changer. Once the user has select the tracks to be recorded, and has placed them in a desired order, the CD recorder controls the CD changer to play each of the tracks selected for extraction and subsequent burning onto the blank CD. Still other advantages, aspects, and embodiments of the invention will become apparent by reading the detailed description that follows, and by referring to the accompanying drawings.

### BRIEF DESCRIPTION OF DRAWINGS

FIG. 1 is a block diagram of a compact disc (CD) recorder system according to an embodiment of the invention.

FIGS. 2A and 2B are diagrams of specific embodiments of the inputs of the CD recorder of FIG. 1, specifically an optical audio jack and a pair of analog jacks, respectively.

FIGS. 3A and 3B are diagrams of specific embodiments of the control mechanisms of the CD recorder of FIG. 1, specifically a Sony S-Link jack and an infrared emitter, respectively.

FIG. 4 is a block diagram of a specific embodiment of the user interface mechanism of the CD recorder of FIG. 1.

FIG. 5 is a diagram of a specific embodiment of the CD recording mechanism of the CD recorder of FIG. 1.

FIG. 6 is a flowchart of a method for burning a CD with tracks extracted from CD's stored in CD changers, according to an embodiment of the invention.

FIGS. 7A, 7B, 7C, and 7D are diagrams of example screens that may be displayed to the user during CD track selection and CD burning when the method of FIG. 6 is performed.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Compact Disc (CD) Recorder

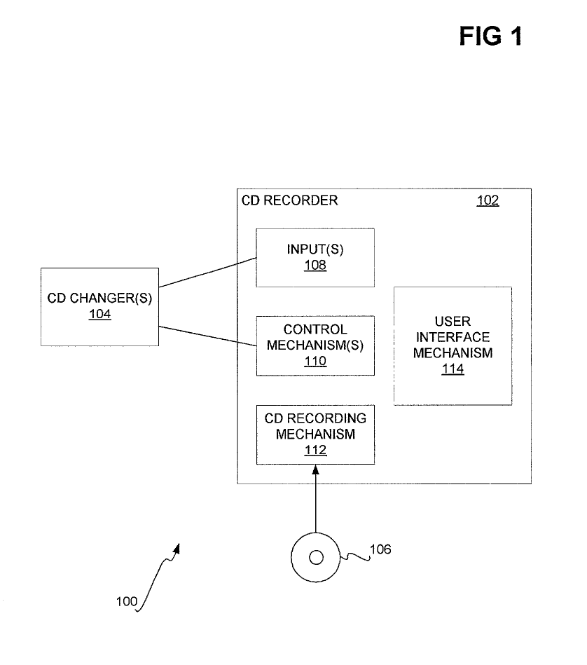

FIG. 1 shows a CD recorder system 100 according to an embodiment of the invention. The system 100 includes a CD recorder 102 communicatively coupled to one or more CD changers 104, and into which a blank CD 106 can be inserted. The CD recorder 102 includes one or more inputs 108, one or more control mechanisms 110, a CD recording mechanism 112, and a user interface mechanism 114. The inputs 108 and the mechanism 110 can alternatively be a single connection or mechanism, and this is within the scope of the claims of the invention. The CD recorder 102 may be a specialized audio component. Alternatively, the CD recorder 102 may be a general-purposed computer, such as a desktop or notebook computer, specially programmed to perform functionality described herein.

The inputs 108 connect to the CD changers 104, so that audio information can be received from the CD changers 104 when they play CD's. The control mechanisms 110 also connect to the CD changers 104, so that the CD recorder 102 can control the changers 104. The CD recording mechanism 112 is receptive to the blank CD 106, and is capable of recording a desired ordered list of tracks from CD's stored in the changers 104 onto the blank CD 106. The user interface mechanism 114 allows a user to select the desired ordered list of tracks from the CD's stored in the changers 114 for recording onto the blank CD 106 by the CD recording mechanism 112.

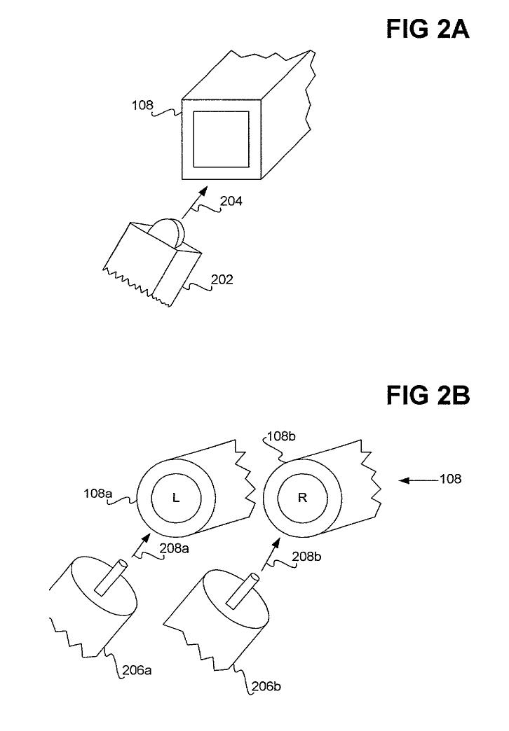

FIGS. 2A and 2B show specific embodiments of the inputs 108. In FIG. 2A, one example of the inputs 108 is shown as an optical audio jack, into which an optical audio plug 202 of a CD changer is inserted, as indicated by the arrow 204. The optical audio jack may be a TOS-link optical audio jack, a coaxial optical audio jack, or another type of optical audio jack. In FIG. 2B, another example of the inputs 108 is shown as a pair of analog RCA jacks 108a and 108b, for left and right audio channels, respectively, into which analog RCA plugs 206a and 206b of a CD changer are inserted, as indicated by the arrows 208a and 208b. Other types of inputs 108 are also amenable to the invention.

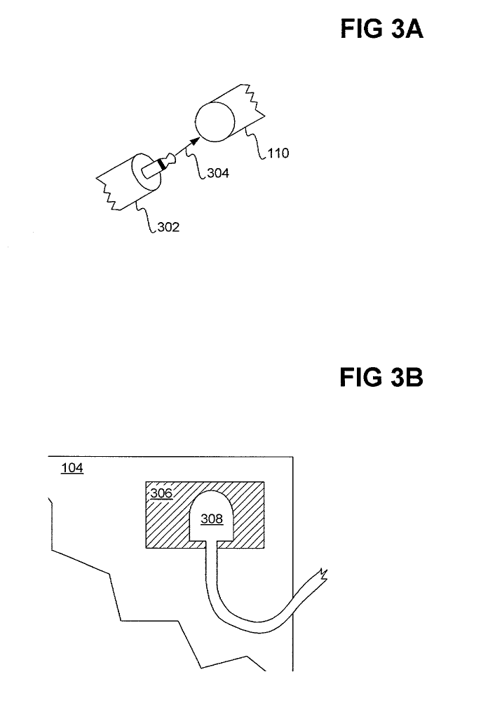

FIGS. 3A and 3B show specific embodiments of the control mechanisms 110. In FIG. 3A, an example of the control mechanism 110 is shown as a Sony S-Link jack, into which a Sony S-Link plug 302 of a control cable connected to a corresponding jack of a CD changer is inserted, as indicated by the arrow 304. S-Link is a protocol used by Sony audio/video components to talk to each other. It encompasses Control-S, an overall control protocol based on infrared codes, Control-A1, a bi-directional protocol used to get CD information from CD players, and Control-L, a time protocol used by high-end video components. Most newer Sony components have an S-Link connector.

In FIG. 3B, another example of the control mechanisms 110 is shown as an infrared emitter 308 of an infrared emitter cable that plugs into an infrared emitter jack of the CD recorder 102, and that is placed substantially near or on the infrared window 306 of one of the CD changers 104. Infrared emitters generally act as remote controls do for the CD changers 104. A direct current (DC) signal generated by the CD recorder 102 that corresponds to a particular infrared code for one of the CD changers 104 is converted into an infrared signal for transmission to this CD changer. In this way, the control mechanisms 110 are able to control the CD changers 104.

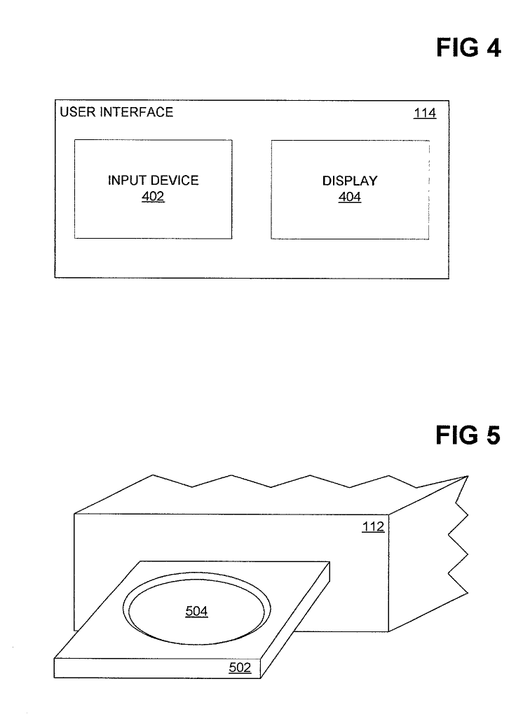

FIG. 4 shows a specific embodiment of the user interface mechanism 114. The mechanism 114 includes an input device 402 and a display 404, or alternatively, connections for communicatively connecting such an input device 402 and such a display 404. The input device 402 receives the selection of the desired ordered list of tracks to be recorded from the user. The input device 402 may be one or more of a remote control, a keyboard, a pointing device such as a mouse, and/or other types of input devices. The display 404 provides visual feedback to the user during selection of the desired order list of the tracks, as well as status of CD burning, and so on. The display 404 may be one or more of a television screen, a computer monitor, a cathode-ray tube (CRT) display, a liquid crystal display (LCD), and/or other types of displays.

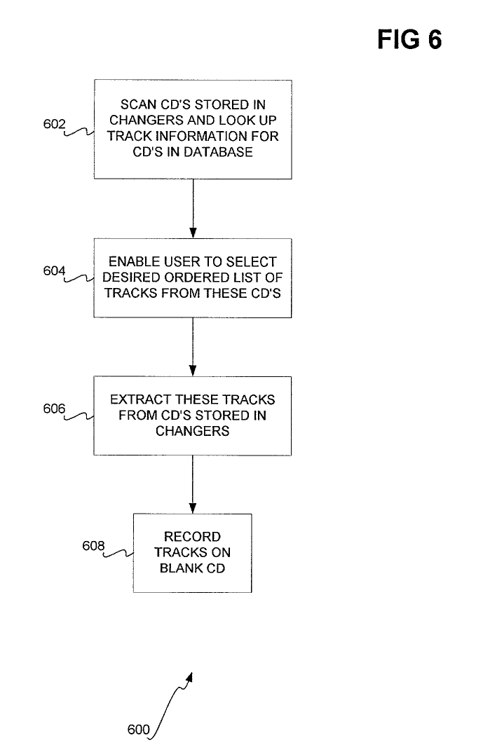

FIG. 5 shows a specific embodiment of the CD recording mechanism 112. The mechanism 112 includes a tray 502 that extends out from the mechanism 112, and that is receptive to placement of a blank CD in a demarcated area 504. Other types of CD and other media recording mechanisms are also amenable to the invention. For instance, the CD recording mechanism 112 is more generally a media recording mechanism for recording the desired list of tracks selected by the user from CD's stored in the CD changers 104 onto more generally a blank medium. The blank medium may be one or more of a CD, a flash memory, a compact flash (CF) card, a smart media (SM) card, a secure digital (SD) card, as well as other types of blank media. Furthermore, the format of the audio information stored on the blank medium is not limited by the invention, and may include MP3-formatted audio information, and so on.

### Method

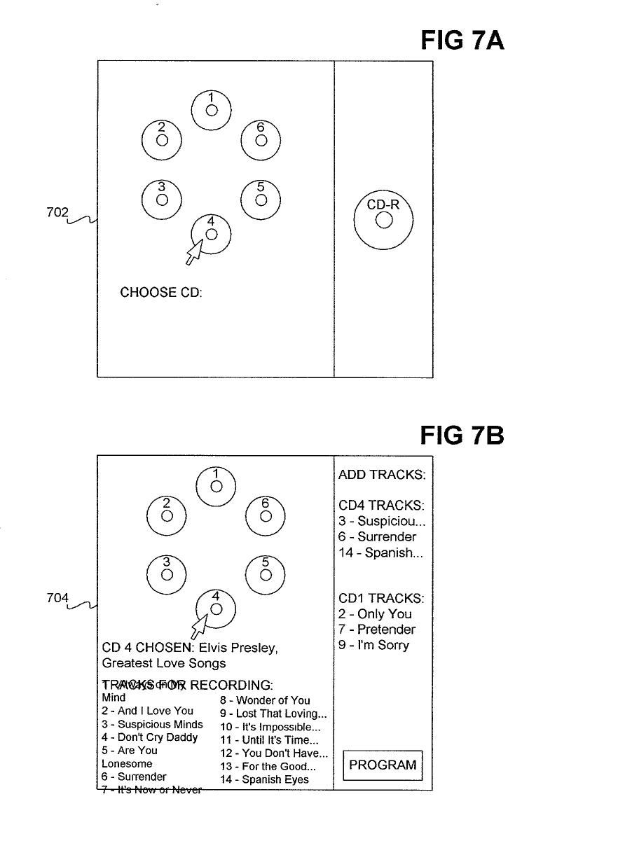

FIG. 6 shows a method 600 as to how one embodiment burns a CD with tracks extracted from CD's stored in CD changers. The method 600 can be performed in conjunction with the CD recording system 100 of FIG. 1 that has been described. Furthermore, the method 600 can be implemented as a computer program stored on a computer-readable medium, such as a memory or a floppy disk, for execution by a processor.

First, the CD's stored in the CD changers 104 are scanned, and at least track information is preferably looked up in a database (602). Besides track information, the name of the CD and the name(s) of the artist(s) may also be looked up in the database. Where the CD recorder 102 has an Internet connection, the database may be the CDDB database, also known as the online music CD database, which is commonly accessible over the Internet. The track information typically includes the name of each track of each CD stored in the CD changers 104, allowing the user to more easily and conveniently select desired tracks for burning on a blank CD.

The user is then enabled to select a desired ordered list of tracks from the CD's stored in the CD changers 104, through the user interface mechanism 114 (604). The user may review what music is stored on these CD's by reviewing the names of the tracks, and then selecting the tracks he or she desires to store on the blank CD. Preferably, the user is able to add and remove desired tracks, as well as change the order in which they are to be burned on the blank CD.

Once the user has finally selected the desired ordered list of tracks, these tracks are extracted from the CD's stored in the changers 104 (606). This is accomplished by the CD recorder 102 controlling the changers 104 through the control mechanism 110, and then receiving the audio information of these tracks through the inputs 108 for extraction. For instance, for each CD having one or more tracks on the desired ordered list of tracks, one of the CD changers 104 on which the CD is located may be controlled, to play these tracks for extraction by the CD recorder 102 while they are being played. This can include instructing the appropriate CD changer to select the appropriate CD, and then to play the appropriate tracks of this CD. This process is repeated until the audio information for all of the tracks of the desired ordered list of tracks has been extracted.

Finally, the desired ordered list of tracks as has been extracted is recorded onto the blank CD (608). This is accomplished by the CD recording mechanism 112 of the CD recorder 102, where the blank CD 106 has been inserted into the CD recording mechanism 112. The method 600 is then finished.

### Example Display Screens

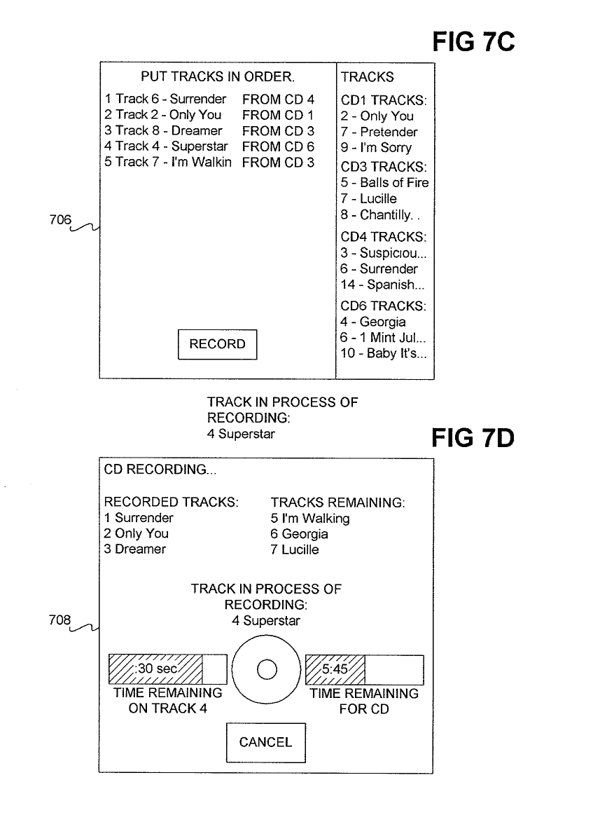

FIGS. 7A-7D show an illustrative example of the information that may be displayed to the user during performance of the method 600 when using the CD recording system 100. The screens 702, 704, 706, and 708 of FIGS. 7A, 7B, 7C, and 7D, respectively, are displayed to the user on the display 404 of the user interface mechanism 114. The screens are specifically those shown to the user during the selection performed by the user in 604 of the method 600, and are particular to those for a carousel-type CD changer. First, as shown in the screen 702 of FIG. 7A, the user is able to select one of the CD's stored in the CD changer. Once the user has selected one of these CD's, the user can select tracks from this CD, as shown in the screen 704 of FIG. 7B. The screens 702 and 704 can be repeated until the user has selected all the desired tracks.

Next, as shown in the screen 706 of FIG. 7C, the user has the opportunity to place the tracks in the desired order, and then start the recording process. The recording process involves 606 and 608 of the method 600, where, as shown in the screen 708 of FIG. 7D, the user can view the status of the recording on the blank CD. The blank CD is referred to as a CD-R in FIG. 7D, as can be appreciated by those of ordinary skill within the art. The screens of FIGS. 7A-7D are shown and described as an example only, and do not represent a limitation on the invention as to how information is conveyed to the user during the selection, extraction, and/or burning processes.

### Conclusion

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A compact disc (CD) recorder comprising:
one or more inputs to receive audio information from one or more corresponding CD changers;
one or more control mechanisms to control the one or more corresponding CD changers;
a user interface mechanism to allow a user to select a desired ordered list of tracks from CD's stored in the one or more corresponding CD changers for recording onto a blank CD; and,
a CD recording mechanism receptive to the blank CD and capable of recording the desired ordered list of tracks selected by the user from the CD's stored in the one or more corresponding CD changers onto the blank CD.

2. The CD recorder of claim 1, wherein the one or more inputs comprise one or more digital inputs.

3. The CD recorder of claim 1, wherein the one or more inputs comprise one or more pairs of analog inputs.

4. The CD recorder of claim 1, wherein the one or more control mechanisms comprise one or more jacks, each jack receptive to a control cable to plug into a corresponding jack of one of the one or more corresponding CD changers.

5. The CD recorder of claim 1, wherein the one or more control mechanisms comprise one or more infrared emitter jacks, each infrared emitter jack receptive to an infrared emitter cable for placement at least substantially near an infrared window of one of the one or more corresponding CD changers.

6. The CD recorder of claim 1, wherein the user interface mechanism comprises a display to provide visual feedback to the user during selection of the desired order list of tracks.

7. The CD recorder of claim 6, wherein the display comprises one or more of: a television screen, a computer monitor, a cathode-ray tube (CRT) display, and a liquid crystal display (LCD).

8. The CD recorder of claim 1, wherein the user interface mechanism comprises a display connection communicatively connectable to a display to provide visual feedback to the user during selection of the desired order list of tracks.

9. The CD recorder of claim 1, wherein the user interface mechanism comprises an input device to receive the selection of the desired ordered list of tracks from the user.

10. The CD recorder of claim 9, wherein the input device comprises one or more of: a remote control, a keyboard, and a pointing device.

11. The CD recorder of claim 1, wherein the user interface mechanism comprises an input device connection communicatively connectable to an input device to receive the selection of the desired ordered list of tracks from the user.

12. The CD recorder of claim 1, wherein the CD recorder comprises a specialized audio component.

13. The CD recorder of claim 1, wherein the CD recorder comprises a programmed general-purpose computer.

14. A media recorder comprising:
one or more inputs to receive audio information from one or more corresponding CD changers;
one or more control mechanisms to control the one or more corresponding CD changers;
a user interface mechanism to allow a user to select a desired ordered list of tracks from CD's stored in the one or more corresponding CD changers for recording onto a blank medium; and,
a media recording mechanism receptive to the blank medium and capable of recording the desired ordered list of tracks selected by the user from the CD's stored in the one or more corresponding CD changers onto the blank medium.

15. The media recorder of claim 14, wherein the media recording mechanism is one or more of: a CD recording mechanism, a flash memory recording mechanism, a compact flash (CF) card recording mechanism, a smart media (SM) card recording mechanism, and a secure digital (SD) card recording mechanism.

16. A method comprising:
enabling selection by a user of a desired ordered list of tracks from compact discs (CD's) stored in one or more CD changers;
extracting the desired ordered list of tracks from the CD's stored in the one or more CD changers, including automatically controlling the one or more CD changers to play the desired ordered list of tracks from the CD's; and,
recording the desired ordered list of tracks from the CD's stored in the one or more CD changers as extracted onto a blank CD inserted into a CD recording mechanism.

17. The method of claim 16, further initially comprising scanning each of the CD's stored in the one or more CD changers and looking up each of the CD's stored in the one or more CD changers in a database to determine at least names of tracks of each of the CD's.

18. The method of claim 16, wherein extracting the desired ordered list of tracks from the CD's comprises, for each CD having one or more tracks on the desired ordered list of tracks:
controlling one of the one or more CD changers in which the CD is located to play one of the one or more tracks of the desired ordered list of tracks on the CD;
extracting the one of the one or more tracks of the desired ordered list of tracks on the CD while being played by the one of the one or more CD changers; and,
repeating controlling and extracting until all of the one or more tracks of the desired ordered list of tracks on the CD have been extracted.

19. A computer-readable medium having instructions stored thereon for execution by a processor to perform a method comprising:
scanning each of a number of compact discs (CD's) stored in one or more CD changers and looking up each of the CD's stored in the one or more CD changers in a database to determine at least names of tracks of each of the CD's;
enabling selection by a user of a desired ordered list of tracks from the CD's stored in the one or more CD changers, by the names of the tracks of the CD's;
extracting the desired ordered list of tracks from the CD's stored in the one or more CD changers, including automatically controlling the one or more CD changers to play the desired ordered list of tracks from the CD's; and,
recording the desired ordered list of tracks from the CD's stored in the one or more CD changers as extracted onto a blank medium inserted into a media recording mechanism.

20. The medium of claim 19, wherein the media recording mechanism is one or more of: a CD recording mechanism, a flash memory recording mechanism, a compact flash (CF) card recording mechanism, a smart media (SM) card recording mechanism, and a secure digital (SD) card recording mechanism.
